(19) United States
(12) Patent Application Publication
(10) Pub. No.: US 2025/0119828 A1
(43) Pub. Date: Apr. 10, 2025

(54) ENERGY EFFICIENT DISTRIBUTED ANTENNA SYSTEM AND METHOD

(71) Applicant: Nextivity, Inc., San Diego, CA (US)

(72) Inventors: Frederic Hayem, San Diego, CA (US); Michiel Petrus Lotter, Poway, CA (US)

(21) Appl. No.: 18/911,628

(22) Filed: Oct. 10, 2024

Related U.S. Application Data
(60) Provisional application No. 63/543,441, filed on Oct. 10, 2023.

(51) Int. Cl. H04W 52/02; H04W 88/08

(52) U.S. Cl. CPC H04W 52/0206; H04W 88/085

(57) ABSTRACT

An energy efficient distributed antenna system (DAS) includes a signal distribution network that includes one or more antenna devices. Each of the one or more antenna devices is configured to receive and transmit signals via an antenna for wireless communications or via a wired connection for wired communications, each of the one or more antenna devices including one or more sensors for sensing an aspect of an environment of the associated antenna device to generate sensor data. The DAS further includes a sensor processor connected with the signal distribution network and configured to receive and process the sensor data, the sensor processor being further configured to control an energy consumption level of the signal distribution network based on the processed sensor data.

### CROSS REFERENCE TO RELATED APPLICATION

This application claims the benefit of U.S. Provisional Application No. 63/543,441, filed Oct. 10, 2023, entitled “ENERGY EFFICIENT DISTRIBUTED ANTENNA SYSTEM AND METHOD”, the disclosure of which is incorporated, in its entirety by this reference.

### BACKGROUND

In-building wireless communication coverage is often provided using either repeater systems or Distributed Antenna Systems (DAS), particularly for enhanced communications. A DAS can include a central unit, often called a head-end or a network unit (NU), and one or more remote units or coverage units (CUs). As the size of a DAS, number of frequency bands supported, output powers and frequency of operation increases, the total consumed energy of DAS can rapidly rise leading to increased operational costs.

One standard method to control the power consumption of a DAS is to either turn off the power to the DAS based on a set schedule, or to enter a low power consumption state based on a schedule. For example, a DAS deployed in an office building need not consume the same amount of energy at night when the office is empty as it does during the day. However, such ways of controlling the power can lead to reduced energy consumption during set times only but cannot fully harness the available energy savings.

What is needed is an energy efficient DAS and method that can maximize energy savings.

### SUMMARY

A system and method to manage the energy consumption of a DAS is described.

In one aspect, an energy efficient distributed antenna system (DAS) includes a signal distribution network that includes one or more antenna devices. Each of the one or more antenna devices is configured to receive and transmit signals via an antenna for wireless communications or via a wired connection for wired communications, each of the one or more antenna devices including one or more sensors for sensing an aspect of an environment of the associated antenna device to generate sensor data. The DAS further includes a sensor processor connected with the signal distribution network and configured to receive and process the sensor data, the sensor processor being further configured to control an energy consumption level of the signal distribution network based on the processed sensor data.

In some aspects, a DAS includes antennas with embedded sensors that can detect the presence of people in the vicinity of the antenna, a sensor processor in the antenna configured to analyze the sensor output to determine if a signal is to be transmitted and a means to send a message to a central processing node where it is determined if the DAS segment is required to be in full operational mode and means to reduce the energy consumption of the DAS when operation is not required by one or more antennas.

In other aspects, the system includes a second input to the decision-making process to represent a level of uplink input signals being received by the antenna or combination of antennas in the DAS. A first input from the embedded sensors and/or the second input can be processed by a processor to modify the operational node of the DAS to optimize energy efficiency.

The details of one or more embodiments are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings.

FIG. 1 illustrates a DAS that includes energy efficient systems; and

FIG. 2 illustrates an antenna device, in accordance with the disclosure herein.

Like reference symbols in the various drawings indicate like elements.

### DETAILED DESCRIPTION

This document describes a distributed antenna system (DAS), and method of operating the same, such as used in an in-building wireless network, such as is described in U.S. Patent Publication Nos. 2021/0377701, 2021/10356611, 2021/10359907, and 2021/1035261, all assigned to Nextivity, Inc., and the contents of which are incorporated herein in their entirety and for all purposes. An energy efficient DAS includes a signal distribution network that includes one or more antenna devices. Each of the one or more antenna devices is configured to receive and transmit signals via an antenna for wireless communications or via a wired connection for wired communications, each of the one or more antenna devices including one or more sensors for sensing an aspect of an environment of the associated antenna device to generate sensor data. The DAS further includes a sensor processor connected with the signal distribution network and configured to receive and process the sensor data, the sensor processor being further configured to control an energy consumption level of the signal distribution network based on the processed sensor data.

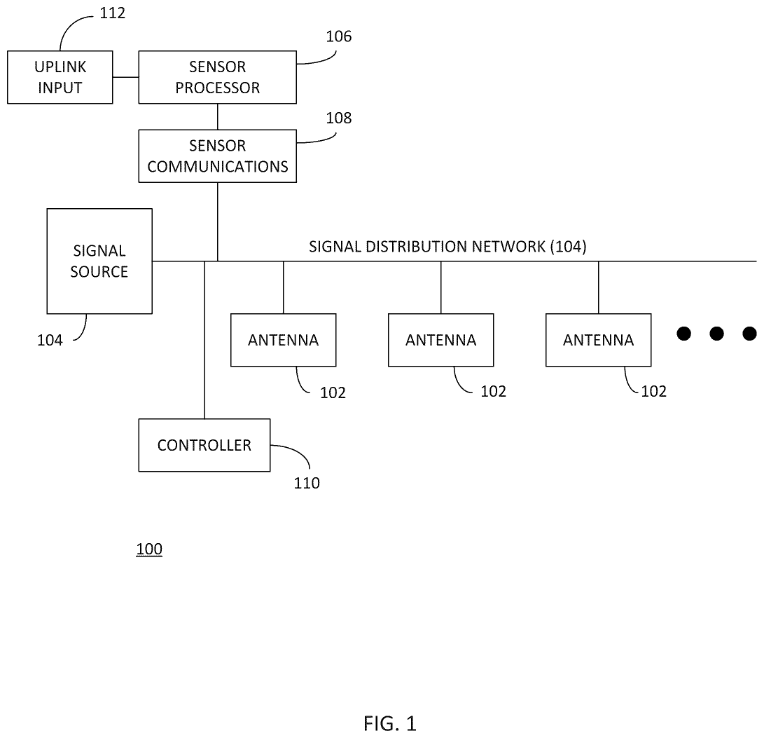

FIG. 1 illustrates a DAS 100, in which a distributed antenna array connected by a signal distribution network 104 is used to provide coverage for a user of the DAS 100. In some implementations, the DAS 100 includes one or more antenna devices 102 configured for transmitting data from a signal source 104 and receiving data from the external environment, and having sensors that can detect the presence of people in the vicinity of the antenna device 102. The sensors can be embedded in, connected to, or integrated with each associated antenna device 102 as described further below. The DAS 100 includes a sensor processor 106, integrated with or otherwise associated with the one or more antenna devices 102, and being configured to analyze the sensor output to determine if a signal is to be transmitted.

Further, the DAS 100 includes a sensor communications module 108 configured with a transmitter or processor that is configured to send a message to a central processing node where it can be determined whether any DAS segment is required to be in full operational mode. For instance, if the sensors detect the absence of any users within a building, or a temperature of an environment within a predefined range, or the absence of other environmental factors such as smoke or other adverse airborne particulates, then the DAS segment can be configured to be in an operating mode that is less than full operational mode.

If full operation is not required by any of the one or more of the antenna devices 102, the DAS 100 includes a controller 110 configured to reduce the energy consumption of the DAS 100. The controller 110 can be implemented in circuitry, such as an application-specific integrated circuit (ASIC), a field programmable gate array (FPGA), and/or as software operating on a computer processor associated with the DAS 100, and can control the operation of selected ones of the one or more antenna devices 102 or other components of the DAS 100.

In other implementations, the DAS 100 includes a second input, i.e., uplink input 112, to the decision-making process of the processor/controller to represent a level of uplink input signals being received by any antenna device 102 or a combination of two or more antenna devices 102 in the DAS 100. The first input from the embedded sensors and/or the second input can be processed by the sensor processor 106 to modify the operational node of the DAS to optimize energy efficiency. In some cases, an energy consumption level can be specified by a user, and the DAS 100 can be configured to adapt to that specification using any and all of the mechanisms described above. For instance, the DAS 100 can be preprogrammed to be more energy efficient during certain hours of the day, such as high-usage, high-cost periods, or during periods in which usage of the DAS 100 is anticipated or predicted to be low, such as when a building is closed or anticipated to have no occupants.

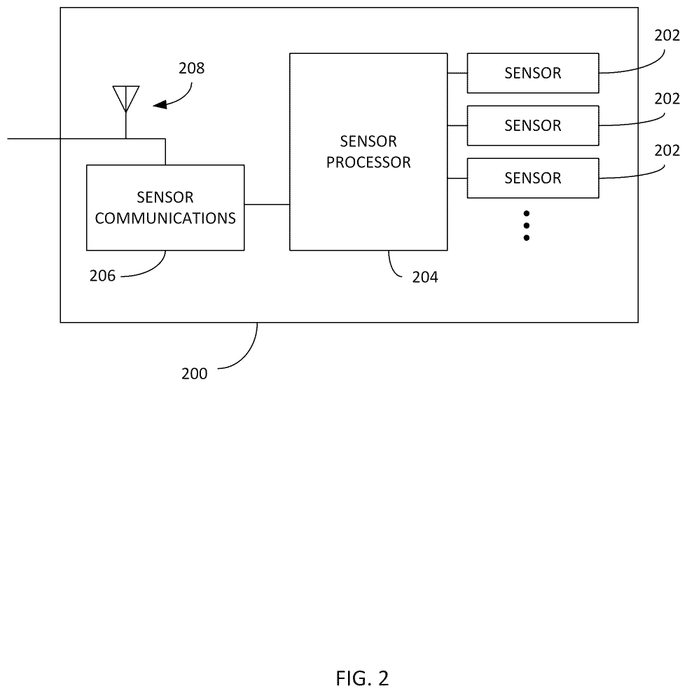

As illustrated in FIG. 2, each antenna device 102, 200 preferably includes one or more sensors 202, which can sense environmental data, such as, for example, whether system users are present in the area of the antenna. The one or more sensors can include a motion sensor, which can be used in cooperation with another motion sensor associated with the antenna or a different antenna, to triangulate a location of a person within a moment in time.

The one or more sensors 202 can also sense other environmental data, such as, without limitation, temperature, sound (such as a shot from a weapon), movement, smoke, or the like. The one or more sensors 202 of each antenna 200 are connected with a sensor processor 204 that is configured to process the signals sensed and provided by each of the one or more sensors 202. For instance, the sensor processor can determine, based on signals received from one of the one or more sensors 202, whether a user is present within an area around the antenna 200. A sensor communications module 206 is configured to determine whether, and how often, sensed and processed signals can be transmitted from the antenna 200 via antenna 208 or by wired connection.

Although a few embodiments have been described in detail above, other modifications are possible. Other embodiments may be within the scope of the following claims.

1. An energy efficient distributed antenna system (DAS), comprising:
a signal distribution network comprising one or more antenna devices, each of the one or more antenna devices being configured to receive and transmit signals via an antenna for wireless communications or via a wired connection for wired communications, each of the one or more antenna devices including one or more sensors for sensing an aspect of an environment of the associated antenna device to generate sensor data; and
a sensor processor connected with the signal distribution network and configured to receive and process the sensor data, the sensor processor being further configured to control an energy consumption level of the signal distribution network based on the processed sensor data.

2. The DAS in accordance with claim 1, wherein at least one of the one or more antenna devices includes a local sensor processor configured to determine the sensor data to transmit to the sensor processor via the antenna or the wired connection.

3. The DAS in accordance with claim 1, wherein the signal distribution network includes a sensor communications module configured to transmit, on an uplink connection, an energy control signal to control the energy consumption level of the DAS.

4. The DAS in accordance with claim 1, wherein the signal distribution network is installed within a building that defines the environment.

5. The DAS in accordance with claim 1, wherein the one or more sensors include one or more of a motion sensor, a temperature sensor, a smoke sensor, and a location sensor.
